(19) United States
(12) Patent Application Publication
(10) Pub. No.: US 2025/0191310 A1
(43) Pub. Date: Jun. 12, 2025

(54) SYSTEM AND METHOD FOR STREAMING DRM CONTENTS

(71) Applicant: Korea Electronics Technology Institute, Seongnam-si (KR)

(72) Inventors: Woo Chool PARK, Incheon (KR); Jun Hwan JANG, Goyang-si (KR); Min Su CHOI, Seoul (KR); Jun Suk LEE, Seoul (KR); Bon Jae KOO, Suwon-si (KR)

(73) Assignee: Korea Electronics Technology Institute, Seongnam-si (KR)

(21) Appl. No.: 18/976,539

(22) Filed: Dec. 11, 2024

(30) Foreign Application Priority Data
Dec. 11, 2023 (KR) 10-2023-0178678

(51) Int. Cl. G06T 19/00; H04L 9/08

(52) U.S. Cl. CPC G06T 19/006; H04L 9/0819

(57) ABSTRACT

Methods and systems for streaming DRM content are disclosed, and specific embodiments of the present disclosure can prevent communication degradation between a DRM server and a client terminal by reconstructing three-dimensional AR objects of DRM content packaged with an encryption key into a predetermined number of resolutions and then streaming them in segments, decrypting the three-dimensional AR objects of each received resolution matching a client authentication authority, and rendering them over a rendered low-resolution single image.

### CROSS REFERENCE TO RELATED APPLICATION

The present application claims priority to a Korean Patent Application No. 10-2023-0178678, filed on Dec. 11, 2023, in the Korean Intellectual Property Office, the entire contents of which are incorporated herein for all purposes by reference.

### TECHNICAL FIELD

The present disclosure relates to a system and method for streaming DRM content, and more specifically, to a technique for reconstructing a three-dimensional AR object of DRM content packaged with an encryption key into a predetermined number of resolutions, then segmenting and streaming the three-dimensional AR object at a resolution matching a client authentication authority, and then decrypting the three-dimensional AR object and rendering it over a rendered lower-resolution single image.

### BACKGROUND

The DRM (Digital Authority Management) authentication method is applied to digital content management systems by decrypting the encrypted object video stream using the decryption key provided by the DRM server to play the content.

Therefore, digital content management systems can prevent illegal distribution and copying of digital content, ensure that only authorized users can use the content, and manage the profitability of digital content copy authority through billing services.

However, digital content management systems have reached the limit that differential distribution of digital content based on various permissions is not possible because the encrypted object video stream and decryption key correspond one to one.

### SUMMARY

The present disclosure is technically directed to provide a system and method for streaming DRM content that can prevent communication degradation between a DRM server and a client terminal by streaming three-dimensional AR objects of DRM content packaged with encryption keys in a predetermined number of resolutions, each of which is reconstructed and then segmented, and decrypting the three-dimensional AR objects of each received resolution matching the client authorization authority and rendering them on top of a rendered single image of a lower resolution.

The objects of the present disclosure are not limited to the above-mentioned objects, and other objects and advantages of the invention not mentioned will be understood from the following description, and will become apparent from the embodiments of the invention. It will also be readily apparent that the objects and advantages of the invention may be realized by the means and combinations thereof shown in the claims.

In accordance with one embodiment of the present disclosure, a DRM content streaming system is characterized to comprise a content server registering a DRM content; a DRM server packaging a three-dimensional augmented reality (AR) object of the registered DRM content with an encryption key, reconstructing the three-dimensional AR object into a predetermined number of resolutions, and streaming the three-dimensional AR object of each reconstructed resolution with segmentation; and a client terminal decrypting the three-dimensional AR object at a resolution matched with a client authentication authority and rendering the decrypted three-dimensional AR object at the resolution over a rendered a low-resolution single image.

Moreover, the DRM server may be configured to reconstruct the three-dimensional AR object into a low-resolution image comprising URL information for a three-dimensional AR object of the registered DRM content as a single image, a medium-resolution image comprising a three-dimensional AR object reconstructed at a higher resolution than the low-resolution single image, and a high-resolution image comprising a three-dimensional AR object reconstructed at a higher resolution than the medium-resolution three-dimensional AR object.

Moreover, the client terminal may be configured to provide the client authentication authority to the DRM server using the URL address of the low-resolution image, receive a decryption key to decrypt one of the medium-resolution image or the high-resolution image that matches the client authentication authority, decrypts one of the medium-resolution or high-resolution three-dimensional AR objects with the received decryption key, renders the decrypted three-dimensional AR objects over the single image rendered at the low-resolution.

Moreover, the client terminal may be configured to provide to the DRM server a retransmission command of a three-dimensional AR object of a streaming index requested by a client among the three-dimensional AR objects of the respective resolutions.

In accordance with another embodiment of the present disclosure, the DRM content streaming method comprises packaging a three-dimensional AR object of a registered DRM content with an encryption key, reconstructing the three-dimensional AR object into a predetermined number of resolutions, and streaming the reconstructed three-dimensional AR objects at each resolution with segmentation.

Moreover, the step of reconstructing by a DRM server may be at least one of a low-resolution image comprising URL information for a three-dimensional AR object of the registered DRM content and a single image, a medium-resolution image comprising a three-dimensional AR object with a higher resolution than the low-resolution image, and a high-resolution image comprising a three-dimensional AR object with a higher resolution than the medium-resolution image.

Moreover, the DRM content streaming method comprises, by a client terminal, providing client authentication authority to the DRM server using the URL address of the low-resolution image, receiving a decryption key to decrypt a three-dimensional AR object with a resolution that matches the client authentication authority, decrypting one of the medium-resolution or high-resolution three-dimensional AR objects with the received decryption key, and rendering the decrypted three-dimensional AR objects over the single image rendered at the low-resolution.

Moreover, the DRM content streaming method may comprise, at the client terminal, by the client terminal, providing, to the DRM server, a retransmission command of a three-dimensional AR object of a streaming index requested by a client among the three-dimensional AR objects of the respective resolutions.

According to this feature, the three-dimensional AR object of the DRM content packaged with encryption key is reconstructed into a predetermined number of resolutions, and then segmented and streamed. The three-dimensional AR object of the resolution matching the client authorization authority among the received images of each resolution is decrypted and rendered over the rendered single image of the lower resolution, thereby preventing communication degradation between the DRM server and the client terminal.

### BRIEF DESCRIPTION OF THE DRAWINGS

The following drawings, which accompany this specification, illustrate preferred embodiments of the present disclosure and serve to further illustrate the technical ideas of the invention in conjunction with the detailed description of the invention that follows, and the invention is not to be construed as limited to what is shown in such drawings.

FIG. 1 shows a block diagram of a DRM content streaming system in one embodiment.

FIG. 2 shows examples of three-dimensional AR images reconstructed at each of the resolutions.

FIG. 3 is a flowchart showing the operation of the DRM content streaming system.

### DETAILED DESCRIPTION

Embodiments of the present disclosure are described below with reference to the accompanying drawings in such detail as to facilitate practice by one of ordinary skill in the art to which the invention belongs. However, the invention may be implemented in many different forms and is not limited to the embodiments described herein. In order to clearly illustrate the invention in the drawings, parts not pertinent to the description have been omitted, and like parts throughout the specification have been designated by like drawing numerals.

One embodiment described below specifically describes a configuration that reconstructs three-dimensional AR objects of DRM content packaged with encryption keys, each in a predetermined number of resolutions, and then streams them in segments, decrypts the three-dimensional AR object of each received resolution matching the client authentication authority, and renders it over a rendered single lower resolution image.

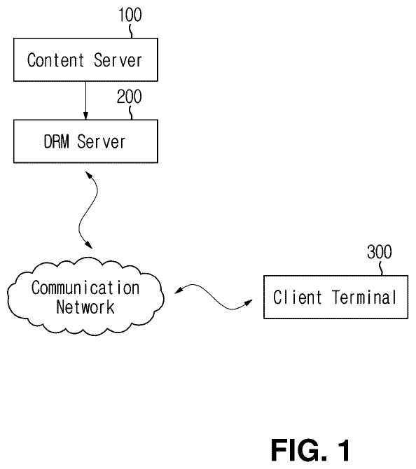

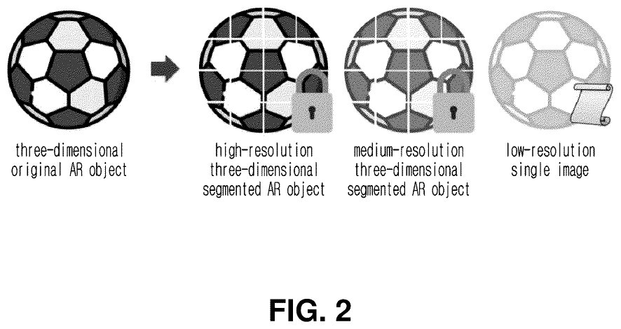

FIG. 1 is a diagram illustrating a configuration of a DRM content streaming system according to one embodiment, and FIG. 2 is an example illustration of a three-dimensional AR object of each resolution of FIG. 1. Referring to FIGS. 1 and 2, a DRM content streaming system according to one embodiment is configured to package a three-dimensional augmented reality (AR) object of DRM content with a predetermined encryption key, reconstruct the three-dimensional AR object in a predetermined number of resolutions, and segment and stream the reconstructed three-dimensional AR object in each resolution, wherein the system includes a content server 100 and a DRM server 200.

The content server 100 registers the DRM content created by the content creator and the registered DRM content is provided to the DRM server 200. The sequence of steps for registering DRM content created by a content creator is not specifically described herein, as will be understood by those skilled in the art.

Meanwhile, the DRM server 200 packages the registered DRM content with the encryption key, and then reconstructs the three-dimensional AR object of each DRM content into a predetermined number of resolutions, and then segments and streams them. Here, each of the predetermined number of resolutions may be a low-resolution image comprising a URL information and a single image of the three-dimensional AR object of the registered DRM content, a medium-resolution image comprising a three-dimensional AR object reconstructed at a higher resolution than the single image of the low-resolution image, and a high-resolution image comprising a three-dimensional AR object reconstructed at a higher resolution than the three-dimensional AR object of the medium-resolution image.

The DRM content streaming system of one embodiment further includes a client terminal 300, wherein the client terminal 300 is a device owned by a client that provides a client authentication authority to the DRM server 200 based on the URL information of the received the low-resolution image. The DRM server 200 generates and transmits a decryption key matching the client authentication authority to the client terminal 300.

Accordingly, the client terminal 300 decrypts the resolution image matching the client authorization authority with the decryption key received among the medium-resolution image and the high-resolution image, and then renders the decrypted three-dimensional AR object on the rendered low-resolution single image. Accordingly, one embodiment can prevent deterioration of communication between the DRM server and the client terminal by reconstructing the three-dimensional AR object of the DRM content packaged with the encryption key in a predetermined number of resolutions and then streaming it in segments, decrypting the three-dimensional AR object of the resolution matching the client authentication authority among the received images of each resolution, and then rendering the decrypted three-dimensional AR object on a rendered single image of the low resolution.

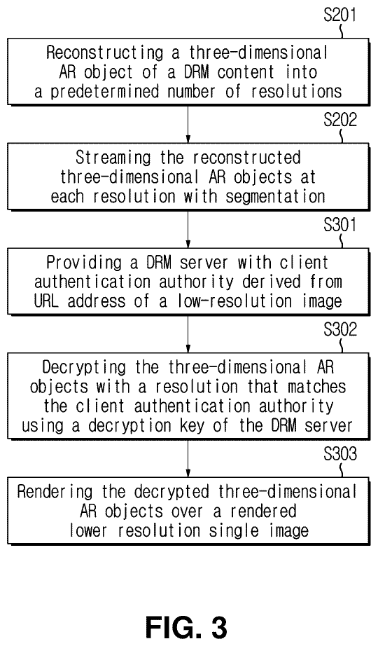

FIG. 3 is an overall flow diagram illustrating the operation of the DRM content streaming system of FIG. 1. Referring now to FIG. 3, a method of streaming DRM content according to another embodiment of the present disclosure will be described.

First, the DRM server 200 in one embodiment packages the DRM content registered in the content server 100 with a predetermined encryption key and reconstructs the three-dimensional AR objects of the DRM content into a predetermined number of resolutions (step S201). The DRM server 200 then streams the reconstructed three-dimensional AR objects of each predetermined number of resolutions into low-resolution images including a single image and URL information with segmentation (step S202).

Furthermore, the client terminal 300 in one embodiment provides the client authentication authority derived from the low-resolution URL information to the DRM server 200 (step S301). The DRM server 200 generates a decryption key matching the client authentication authority and delivers it to the client terminal 300. The client terminal 300 decrypts a predetermined number of three-dimensional AR objects of a resolution matching the client authentication authority with the received decryption key (step S302).

The client terminal 300 renders the decrypted three-dimensional AR object over the rendered single low-resolution image (step 303).

Accordingly, one embodiment may reconstruct three-dimensional AR objects of DRM content packaged with encryption keys, each with a predetermined number of resolutions, and then stream them in segments, decrypting the three-dimensional AR object of each received resolution that matches the client authentication authority, and rendering it over a rendered single lower resolution image to avoid degraded communication between the DRM server and the client terminal.

For ease of understanding, a single processor is sometimes described as being used, but one of ordinary skill in the art will recognize that a processing device may include a plurality of processing elements and/or multiple types of processing elements. For example, a processor may include a plurality of processors or one processor and one controller. Other processing configurations are also possible, such as parallel processors.

Here, the software may include a computer program, code, instructions, or one or more combinations thereof, and may configure the processing device to operate as desired, or may independently or collectively instruct the processing device.

Software and/or information, signals, and data may be permanently or temporarily embodied in any type of machine, component, physical device, virtual equipment, computer storage medium or device, or transmitted signal wave, in order to be interpreted by a control or to provide instructions or data to a processing device. Software may also be distributed on networked computer systems and stored or executed in a distributed manner. The software and data may be stored on one or more computer-readable recording mediums.

The methods according to embodiments may be implemented in the form of program instructions that may be executed through various computer means and recorded on a computer-readable medium. The computer-readable medium may include program instructions, data files, data structures, and the like, singly or in combination. The program instructions recorded on the medium may be specifically designed and configured for the embodiments or may be known and available to those skilled in the art of computer software.

Examples of computer-readable recording media include magnetic media, such as hard disks, floppy disks, and magnetic tape; optical media, such as CD-ROMs and DVDs; magneto-optical media, such as floppy disks; and hardware devices specifically configured to store and execute program instructions, such as ROMs, RAM, flash memory, and the like.

Examples of program instructions include machine language code, such as that created by a compiler, as well as high-level language code that can be executed by a computer using an interpreter.

The hardware devices described above may be configured to operate as one or more software modules to perform the operations of the embodiments, and vice versa. Although the above embodiments have been described by way of limited examples and drawings, various modifications and variations from the above description will be apparent to one of ordinary skill in the art. For example, the techniques described may be performed in a different order than described, and/or the components of the described systems, structures, devices, circuits, etc. may be combined or assembled in a different form than described, or substituted or replaced by other components or equivalents, while still achieving the desired results.

Therefore, the scope of the invention should not be limited to the described embodiments, but should be defined by the following claims as well as those equivalents thereof.

What is claimed is:

1. A DRM content streaming system comprising;
a content server registering a DRM content;
a DRM server packaging a three-dimensional augmented reality (AR) object of the registered DRM content with an encryption key, reconstructing the three-dimensional AR object into a predetermined number of resolutions, and streaming the three-dimensional AR object of each reconstructed resolution with segmentation; and
a client terminal decrypting the three-dimensional AR object at a resolution matched with a client authentication authority and rendering the decrypted three-dimensional AR object at the resolution over a rendered a low-resolution single image.

2. The DRM content streaming system of claim 1, wherein the DRM server reconstructs the three-dimensional AR object into,
a low-resolution image comprising URL information for a three-dimensional AR object of the registered DRM content as a single image,
a medium-resolution image comprising a three-dimensional AR object reconstructed at a higher resolution than the low-resolution single image, and
a high-resolution image comprising a three-dimensional AR object reconstructed at a higher resolution than the medium-resolution three-dimensional AR object.

3. The DRM content streaming system of claim 1, wherein the client terminal is configured to,
provides the client authentication authority to the DRM server using the URL address of the low-resolution image,
receive a decryption key to decrypt one of the medium-resolution image or the high-resolution image that matches the client authentication authority,
decrypts one of the medium-resolution or high-resolution three-dimensional AR objects with the received decryption key,
renders the decrypted three-dimensional AR objects over the single image rendered at the low-resolution.

4. The DRM content streaming system of claim 3, wherein the client terminal is configured to,
provides, to the DRM server, a retransmission command of a three-dimensional AR object of a streaming index requested by a client among the three-dimensional AR objects of the respective resolutions

5. A DRM content streaming method, the method comprising,
packaging a three-dimensional AR object of a registered DRM content with an encryption key;
reconstructing the three-dimensional AR object into a predetermined number of resolutions; and
streaming the reconstructed three-dimensional AR objects at each resolution with segmentation.

6. The method of claim 5, wherein the reconstructing comprises, by a DRM server,
a low-resolution image comprising URL information for a three-dimensional AR object of the registered DRM content and a single image;
a medium-resolution image comprising a three-dimensional AR object with a higher resolution than the low-resolution image; and
a high-resolution image comprising a three-dimensional AR object with a higher resolution than the medium-resolution image.

7. The method of claim 6,
wherein the method further comprises, by a client terminal,
providing client authentication authority to the DRM server using the URL address of the low-resolution image,
receiving a decryption key to decrypt a three-dimensional AR object with a resolution that matches the client authentication authority,
decrypting one of the medium-resolution or high-resolution three-dimensional AR objects with the received decryption key, and
rendering the decrypted three-dimensional AR objects over the single image rendered at the low-resolution.

8. The method of claim 7,
wherein the method further comprises, by the client terminal,
providing, to the DRM server, a retransmission command of a three-dimensional AR object of a streaming index requested by a client among the three-dimensional AR objects of the respective resolutions.

9. A non-transitory computer-readable recording medium characterized by a program recorded thereon for executing on the computer the DRM content streaming method of claim 5.

10. A computer program stored on a computer-readable recording medium that is coupled to a computer to perform a DRM content streaming method on the computer,
wherein the DRM content streaming method comprises,
packaging a three-dimensional AR object of a registered DRM content with an encryption key and reconstructing the packaged three-dimensional AR object into a predetermined number of resolutions;
streaming the reconstructed three-dimensional AR objects at each resolution with segmentation,
providing, by a client terminal, client authentication authority to the DRM server using the URL address of the low-resolution image,
receiving a decryption key to decrypt a three-dimensional AR object with a resolution that matches the client authentication authority,
decrypting one of the medium-resolution or high-resolution three-dimensional AR objects with the received decryption key, and
rendering the decrypted three-dimensional AR objects over the single image rendered at the low-resolution.
